(19) United States
(12) Patent Application Publication
(10) Pub. No.: US 2005/0257894 A1
(43) Pub. Date: Nov. 24, 2005

(54) Embossing and laminating machine with interchangeable embossing cylinders assembly

(75) Inventor: Guglielmo Biagiotti, Capannori (IT)

Correspondence Address: BREINER & BREINER, L.L.C., P.O. BOX 19290, ALEXANDRIA, VA, 22320-0290, US

(73) Assignee: Fabio Perini, Lucca (IT)

(21) Appl. No.: 10/519,161

(22) PCT Filed: Jun. 19, 2003
(86) PCT No.: PCT/IT03/00377

§ 371 Date: Feb. 1, 2005

(30) Foreign Application Priority Data
Jun. 26, 2002 (IT) FI2002A00113

(51) Int. Cl. B31F 1/07

(52) U.S. Cl. 156/553

(57) ABSTRACT

The embossing and laminating device comprises: a supporting structure (3); a first embossing cylinder (9) provided with protuberances (9P); a first pressure roller (21) cooperating with said first embossing cylinder (3); a second embossing cylinder (11), provided with protuberances (11P); a second pressure roller (23) cooperating with said second embossing cylinder (11). The first and the second embossing cylinder (9, 11) are carried by an interchangeable assembly or sub-structure (7), which can be mounted on and removed from the fixed structure.

### TECHNICAL FIELD

The present invention relates to an embossing and laminating device, of the type comprising: a supporting structure; a first embossing cylinder provided with protuberances; a first pressure roller cooperating with said first embossing cylinder; a second embossing cylinder, provided with protuberances; a second pressure roller cooperating with said second embossing cylinder; and if necessary a gluing unit.

### PRIOR ART

Embossing units or devices of this type are commonly utilized in the paper converting industry to produce items made of so-called tissue paper, such as rolls of kitchen towels, paper napkins and the like.

To increase the volume of the paper product and increase its characteristics of fluid absorption, particularly important in the production of kitchen towels for household use, as well as for aesthetic and commercial purposes, two or more plies of paper material are embossed separately and then joined by applying a glue and laminating them between two cylinders, which may be the same embossing cylinders used for the embossing operation.

Embossing consists of mechanical processing in which a ply or a plurality of plies are fed between an embossing cylinder provided with tips or protuberances and a pressure roller if necessary coated in a yielding material, which presses against the embossing cylinder. The ply or plies are thus mechanically deformed and the paper fibres of which they are constituted are deformed and break. The two or more plies thus embossed are joined to one another by applying a glue on the protuberances obtained by embossing on one of the two plies and by laminating the two or more plies together to exert the pressure required to make them adhere.

The embossing devices are characterized, for example, according to the spatial relation between the tips or protuberances produced on the two or more plies joined together. According to a first type of embossing the two plies are embossed separately by two embossing cylinders, each of which cooperates with a pressure roller. In this way protuberances are produced on each ply; these are then brought to coincide with the each other in tip-to-tip joining. In this case this is called tip-to-tip embossing. An example of a device of this type is described in EP-A-0370972. The plies are joined together by laminating in the nip between the two embossing cylinders, where the tips or protuberances of one embossing cylinder coincide with the tips or protuberances of the other embossing cylinder.

Variants td this embossing system have been designed to solve specific problems, for example deriving from the difficulty of making the tips or protuberances of one cylinder coincide with the tips or protuberances of the other when the tips or protuberances are particularly small. Examples of tip-to-tip embossing and laminating devices which constitute a development of the traditional device to solve specific problems are described in U.S. Pat. No. 6,053,232; U.S. Pat. No. 6,032,712; U.S. Pat. No. 6,245,414; U.S. Pat. No. 5,173,351; U.S. Pat. No. 6,109,326; U.S. Pat. No. 5,736,223; U.S. Pat. No. 5,382,464; U.S. Pat. No. 4,376,671.

According to a different technique, the plies are again embossed separately, but joined together in a position so that the protuberances produced on one of the two plies fit into in the spaces between the protuberances of the other ply. In this case this is called nested embossing. For requirements of space and to compensate for bendings of the embossing cylinders during operation, the arrangement of these cylinders in the space varies in tip-to-tip embossing compared to nested embossing.

In this technique the protuberances of the two embossing cylinders are phased differently to the tip-to-tip embossing technique. The two plies are joined together by lamination between one of the two embossing cylinders and a laminating or joining cylinder.

Systems have been designed to process, on the same machine or on the same device, products using the tipoip technique and using the nested technique, with particular arrangements to make the device easily convertible from one operating mode to the other. Examples of solutions to obtain this result are described in WO-A-9941064 and in WO-A-9853985.

In addition to technical-functional reasons, embossing is also utilized to impart particular decorative characteristics on the product. The protuberances produced by embossing may, in fact, be used to reproduce on the product basic decorations with a more or less regular geometrical shape and/or more or less aesthetically elaborate decorative patterns.

It is important to be able to replace the embossing cylinders quickly and with reduced machine idle times to modify the design produced on the final product to satisfy different market requirements.

Ultimately, it may be necessary to replace or adjust the arrangement of the embossing cylinders of an embossing and laminating device in order to modify both the technical-functional characteristics and the aesthetic characteristics of the final product.

Replacement of the embossing cylinders, or even simple modification of their layout, for example from tip-to-tip to nested embossing, is a complex and lengthy operation in particular due to the need to perform precise phasing of the embossing cylinders.

### OBJECTS AND SUMMARY OF THE INVENTION

The object of the present invention is to produce an embossing and laminating device which allows easy replacement of the embossing cylinders to modify the embossing design and/or the embossing and lamination technique.

This and other objects and advantages which shall become clear to those skilled in the art by reading the text hereunder, are in substance obtained with an embossing and laminating device of the type initially mentioned, in which at least the embossing cylinders are carried by an interchangeable assembly or sub-structure, which can be mounted on and removed from the fixed structure. Preferably, the pressure rollers are carried by the fixed structure, and only the embossing cylinders are carried by the interchangeable assembly. This makes the device simpler and makes the interchangeable assembly quicker to replace.

Replacement of the embossing cylinders is made extremely simple and quick. It is possible to have two or more interchangeable assemblies which differ for example in the configuration of the embossing cylinders (tip-to-tip on one assembly and nested on another), or in the different conformation of the tips or protuberances, for example to produce different designs. In contrast, in the preferred embodiment of the invention, the pressure rollers remain on the fixed structure so that a single pair of pressure rollers is used for the embossing cylinders of one or more interchangeable assemblies. In this way it is also extremely simple to replace the interchangeable assembly, as all the actuators and relative pneumatic or hydraulic supply lines remain attached to the fixed structure.

By positioning the embossing cylinders on an interchangeable assembly it is possible to match the phase of the cylinders during initial assembly of the assembly, so that during subsequent replacement of the interchangeable assemblies the phases of the cylinders do not require to be matched, consequently simplifying the operations to replace the interchangeable assembly.

When the interchangeable assembly has embossing cylinders arranged in a nested or equivalent configuration, a laminating roller, cooperating with one of the embossing cylinders, may advantageously be mounted on the same interchangeable assembly.

Advantageously, again for the purpose of simplifying operations to replace one assembly with another, it is possible for the interchangeable assembly also to have the transmission of motion from one embossing cylinder to the other. Transmission may for example be obtained by a pair of toothed wheels aligned with the cylinders and immersed in an oil bath. In this case the user does not require to perform any operation on the mechanical transmission between the embossing cylinders during replacement of one interchangeable assembly with another. Transmission of motion from the fixed part of the device to the interchangeable assembly may advantageously take place with a system that allows quick removal and mounting of the interchangeable assembly, for example by a toothed belt transmission.

Further advantageous characteristics and embodiments of the invention are set forth in the attached claims.

### BRIEF DESCRIPTION OF THE DRAWINGS

The invention shall now be better understood by following the description and attached drawing, which shows a non-limiting practical embodiment of the invention. In the drawing, in which identical parts are indicated with the same reference numbers:

FIG. 1 shows a schematic side view of the embossing and laminating device provided with a first interchangeable assembly of embossing cylinders;

FIG. 2 shows an analogous view to the one in FIG. 1, with the interchangeable assembly separated;

FIG. 3 shows a side view analogous to the view in FIG. 1 with a different embossing cylinder assembly mounted on the device;

FIG. 4 shows a side view of the device and the interchangeable assembly in FIG. 3 separated from the embossing and laminating device;

FIG. 5 shows a schematic side view of a different embodiment of the device; and

FIGS. 6 and 7 show two very schematic plan views of a device according to the invention and of track means for transferring and replacing interchangeable assemblies.

### DETAILED DESCRIPTION OF THE PREFERRED EMBODIMENT OF THE INVENTION

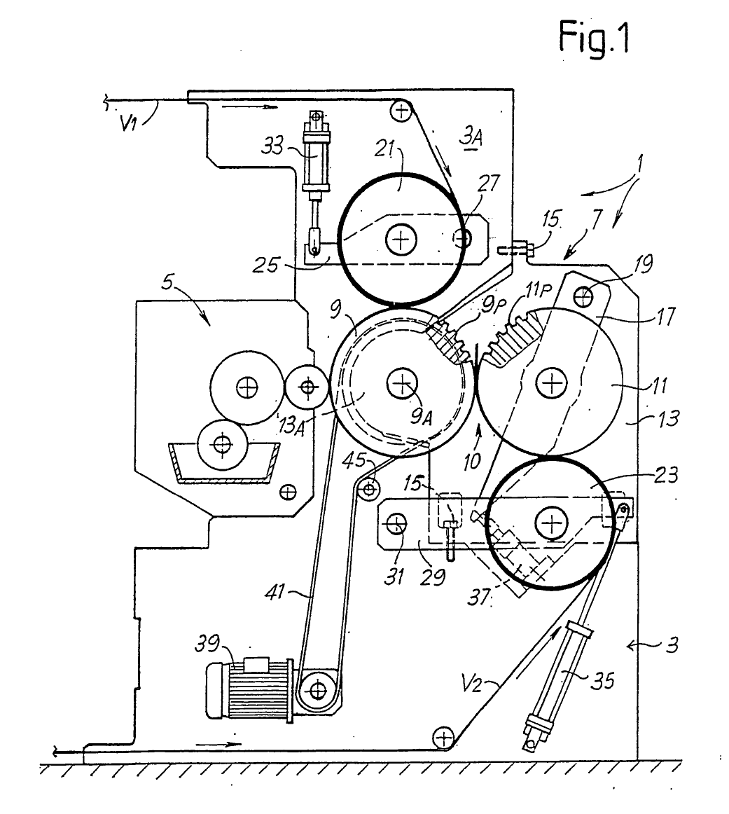

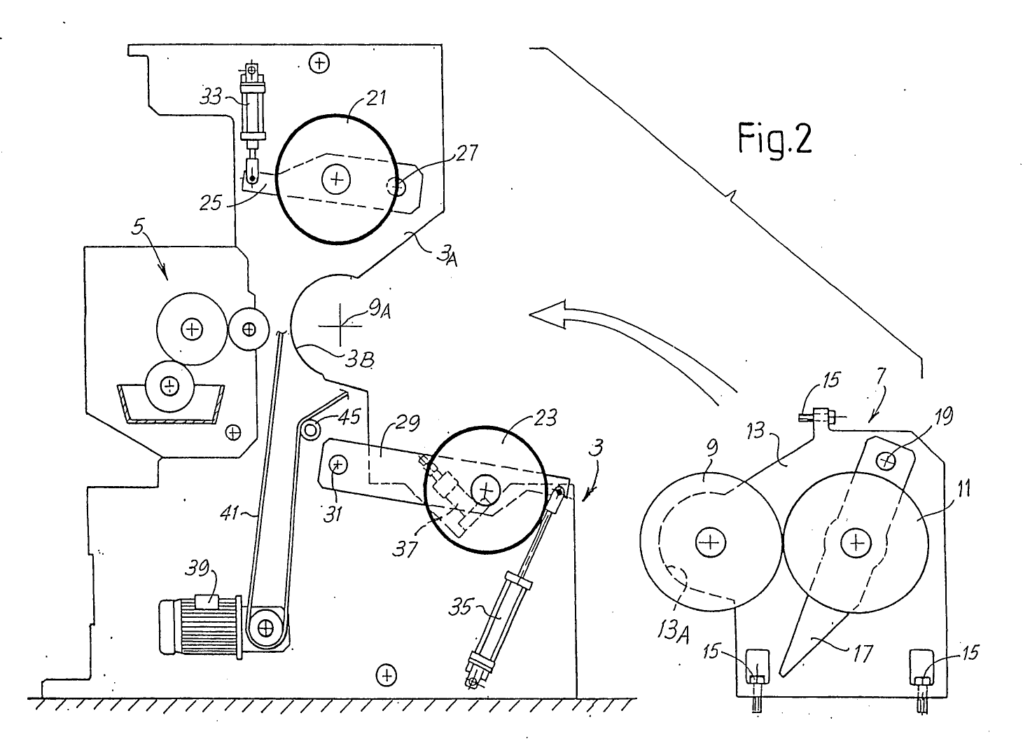

FIGS. 1 and 2 show a first configuration of the device according to the invention. The number 1 generically indicates the device as a whole. This comprises a fixed supporting structure 3, comprising a pair of sides parallel with each other, one of which can be seen in the drawing, the other being substantially identical. A gluing unit, generically indicated with 5 and per se known, is mounted on the fixed supporting structure 3. The gluing unit 5 is positioned on one side of a substantially vertically extending portion 3A of the supporting structure 3, while on the opposite side of said portion 3A is an interchangeable assembly generically indicated with 7, carrying a first embossing cylinder 9 and a second embossing cylinder 11.

The interchangeable assembly 7 comprises a pair of parallel sides 13, which are fixed to the sides of the fixed supporting structure 3 and one of which can be seen in the drawing, the other being substantially identical. In the example shown the sides 13 are fixed to the respective sides of the fixed supporting structure 3 by screw means 15. However, it must be understood that other systems may also be used, such as systems with pneumatic or hydraulic actuators to obtain quicker clamping of the interchangeable assembly 7.

The first embossing cylinder 9 is supported in a fixed position on the interchangeable assembly 7 by supports which are positioned at a projecting portion 13A of the sides 13. In this way in the mounted layout the axle 9A of the first embossing cylinder 9 is aligned with slots 3B (FIG. 2) produced in the vertically extending portion 3A of, the fixed supporting structure 3. The embossing cylinder 9 is provided on its cylindrical surface with protuberances or tips 9P used to emboss the ply of web material fed to it in the way described hereunder.

The second embossing cylinder 11 is supported by a pair of oscillating arms 17 hinged in 19 to the sides 13 of the interchangeable assembly 7, for the purposes described hereunder. The second embossing cylinder 11 is also provided on its cylindrical surface with tips or protuberances 11P. The protuberances 11P and 9P of the two embossing cylinders 9 and 11 are in phase with each other and the reciprocal distance of the two cylinders is such that the protuberances of one cylinder are aligned with the protuberances of the other and are pressed against each other in the lamination nip between the two cylinders, indicated with 10.

A first and a second pressure roller, indicated with 21 and 23 respectively, are mounted on the fixed supporting structure 3. The first pressure roller 21 is supported by a pair of oscillating arms 25 hinged in 27 to the fixed supporting structure 3 and cooperates with the first embossing cylinder 9, while the second pressure roller 23 is carried by a pair of oscillating arms 29 hinged in 31 to the fixed supporting structure 3.

A pair of piston-cylinder actuators 33 press the first pressure roller 21 against the first embossing cylinder 9, while a second pair of piston-cylinder actuators 35 press the second pressure roller 23 against the second embossing cylinder 11.

A third pair of piston-cylinder actuators 37 press the pair of oscillating arms 17 and therefore the second embossing cylinder 11 supported by them against the first embossing cylinder 9.

The first embossing cylinder 9 is drawn in rotation by a central motor 39 or by a transmission the motion of which derives from a different source of motion associated with the line in which the device 1 is fitted. The motion is then transmitted by a belt 41 to the first embossing cylinder 9, keyed on the axle of which is a toothed wheel (not shown), which meshes with a second toothed wheel (again not shown) keyed on the axle of the second embossing cylinder 11, so that the sole motor 39 mounted on the fixed supporting structure 3 carries the two embossing cylinders in rotation. Another belt transmission or equivalent, per se known, may transmit motion to the pressure rollers 21, 23. Alternatively, these may be drawn in rotation by contact with the embossing cylinders 9 and 11. Along the extension of the path of the belt 41 is a tensioning roller 45 adjustable, for example, by a pneumatic actuator. This allows the belt 41 to be loosened or tightened quickly and the interchangeable assembly 7 to be removed or mounted easily.

The diagram in FIG. 1 also shows the paths of two plies V1 and V2 of web material, which are embossed between the pressure roller 21 and the embossing cylinder 9 and between the pressure roller 23 and the embossing cylinder 11 respectively. When the interchangeable assembly 7 is mounted, the pressure rollers 21 and 23 are pressed against the respective embossing cylinders 9, 11, while the latter are pressed against each other at the lamination nip 10. The gluing unit 5 cooperates with the first embossing cylinder 9. In this way the two plies V1 and V2 are embossed and subsequently laminated together in the nip 10, after the glue delivered from the gluing unit 5 has been applied to protuberances produced by the protuberances 9P.

When it is necessary to replace the embossing cylinders 9 and 11, for example to replace them with an assembly that allows nested embossing rather than tip-to-tip embossing, or to replace the cylinders with others provided with protuberances 9P, 11P reproducing a different design, it is sufficient to remove the interchangeable assembly 7 and replace it with another. FIG. 2 shows, separately after removal, the interchangeable assembly 7 and the fixed supporting structure 3 with the mechanical parts which remain mounted on it. The embossing cylinders 9 and 11 remain on the interchangeable assembly 7 and are in phase with each other. Therefore, at the subsequent replacement the assembly can be remounted without requiring any adjustment or reciprocal phasing of the embossing cylinders. Analogously, the embossing cylinders of the other interchangeable assemblies will be in phase with each other. The toothed wheels that transmit motion from one of the two embossing cylinders 9, 11 to the other may be in an oil bath and therefore require no connection to external lubrication systems. Belt transmission 41 with the adjustable tensioning roller 45 allows easy removal of the assembly 7.

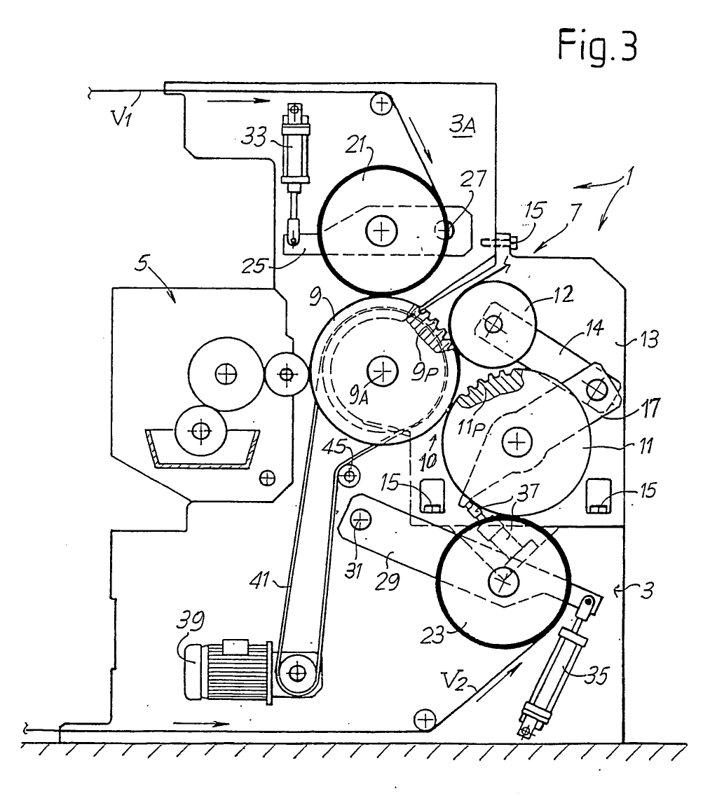

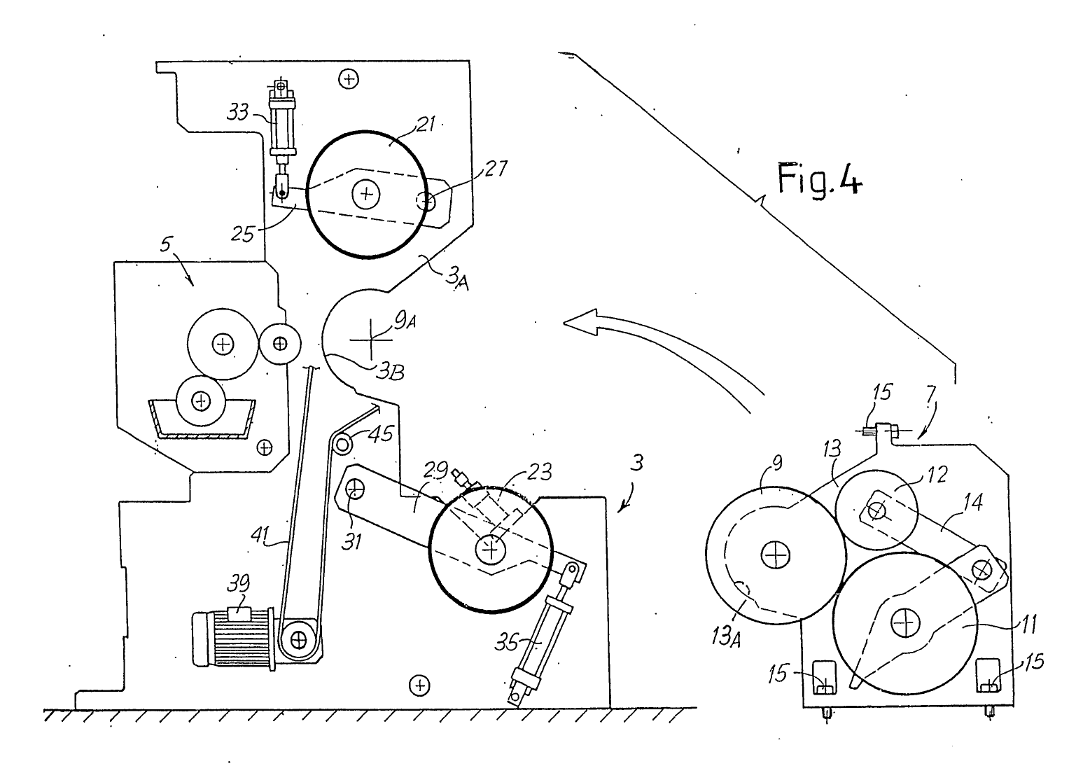

FIGS. 3 and 4 show the same embossing and laminating device 1, with a different interchangeable assembly, again indicated with 7. Identical numbers indicate parts identical or equivalent to those in FIGS. 1 and 2.

The difference compared to the previous example is found in the configuration of the interchangeable assembly 7. In this case this is no longer a tip-to-tip assembly, as in the previous case, but an assembly for nested embossing. The protuberances 9P, 11P of the two embossing cylinders 9 and 11 are arranged so that the protuberances of one cylinder correspond with the empty spaces between the protuberances of the other cylinder. Consequently, the protuberances produced in one ply will be positioned between the protuberances of the other. In the nip 10, which is no longer a lamination nip, there is no reciprocal contact between the embossing cylinders 9 and 11. Lamination between the two plies occurs between the first embossing cylinder 9 and a laminating roller 12, also carried by the interchangeable assembly 7. The laminating roller 12 is carried by a pair of oscillating arms 14 which may be integral with the oscillating arms 17 which carry the second embossing cylinder 11. Alternatively, the arms 14 may oscillate separately from the arms 17 and be provided with their own actuators (not shown).

As can be seen by comparing FIGS. 1 and 3, the two interchangeable assemblies 7 shown in the two figures may replace each other. The pressure rollers 21, 23 easily adapt to the different configuration and arrangement of the embossing cylinders 9 and 11. In particular, the position of the second pressure roller 23 may be adapted to the different position of the second embossing cylinder 11 in the two cases simply by an increased or decreased oscillation of the supporting arms 29.

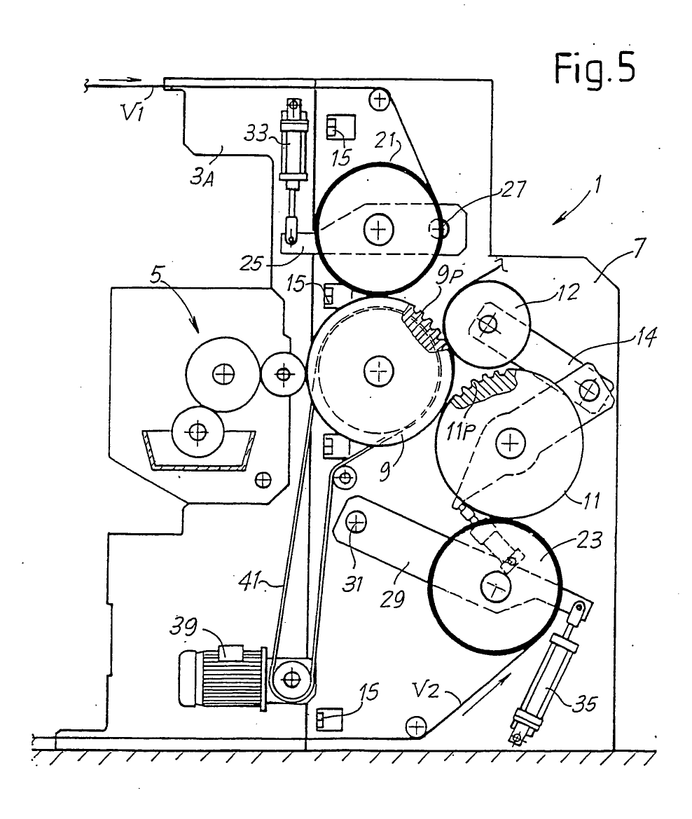

FIG. 5 schematically shows an embodiment in which the interchangeable assembly, indicated again with 7, houses not only the embossing cylinders 9, 11 but also the pressure rollers 21 and 23 and the relative actuators. This configuration is more complex than the previous one, as replacement of the interchangeable assembly implies the need to disconnect and reconnect the electric and hydraulic (or pneumatic) supply lines of the actuators. Nonetheless, there is still the advantage of easier maintenance and elimination of the need to match the phase of the embossing cylinders, as in the previous case.

The interchangeable assemblies 7 may be moved with a bridge crane. Nonetheless, to further facilitate replacement of one assembly with another, tracks or other guiding devices may be provided along which the interchangeable assemblies may be made to slide.

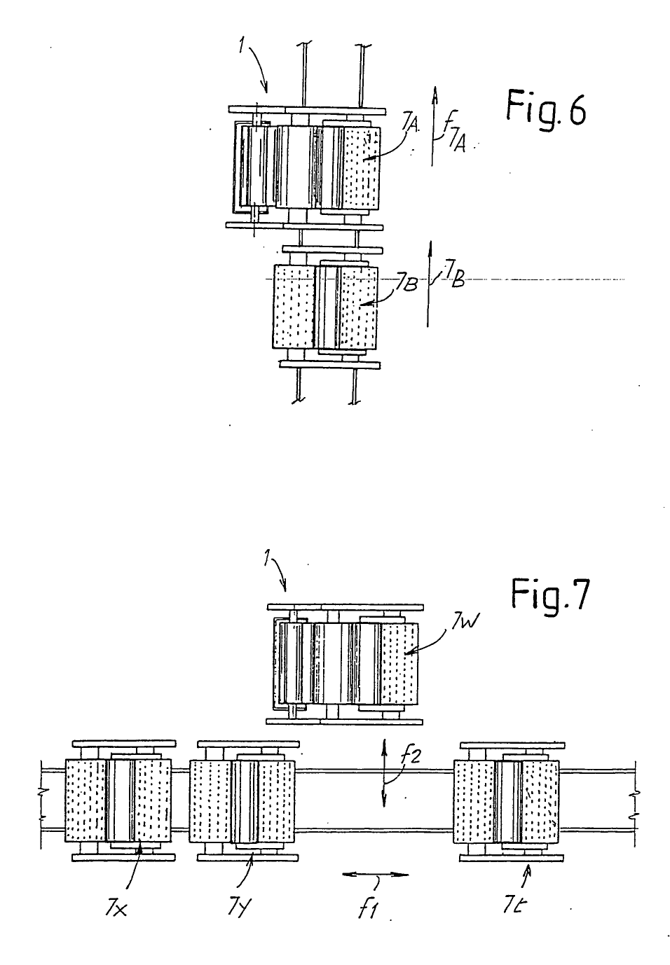

FIG. 6 schematically shows a configuration in which guide components parallel to the axes of the embossing cylinders allow two interchangeable assemblies 7A, 7B to be fitted and removed easily. In the layout shown in the figure the assembly 7A is fitted, while the assembly 7B is standing by at one side of the device. Replacement is obtained by translating the assembly 7A in the direction of the arrow A after having released it, to replace it with the assembly 7B which is fitted in the direction of the arrow B.

In the solution in FIG. 7 a long track is positioned only on one side of the device on which several interchangeable assemblies 7X, 7Y, 7Z are positioned, while an assembly 7″ is in the operating position. Replacement takes place by translating the assemblies along the double arrow f1 and along the double arrow f2.

It is understood that the drawing shows only a practical embodiment of the invention, the forms and arrangements of which may vary without however departing from the scope of the concept underlying the invention. Any reference numerals in the attached claims are provided only to facilitate reading of the claims in the light of the description hereinbefore and the attached drawings and do not limit the scope of protection.

1. An embossing and laminating device for embossing and joining together plies of web material, comprising: a supporting structure; a first embossing cylinder provided with first protuberances; a first pressure roller cooperating with said first embossing cylinder; a second embossing cylinder provided with second protuberances; a second pressure roller cooperating with said second embossing cylinder; wherein at least said first embossing cylinder and said second embossing cylinder are carried by an interchangeable assembly mountable on and removable from the supporting structure.

2. Device as claimed in claim 1, wherein said first embossing cylinder and said second embossing cylinder are carried by said interchangeable assembly, while said first pressure roller and said second pressure roller are carried by the supporting structure.

3. Device as claimed in claim 2, further comprising actuator members positioned on said supporting structure to press the first pressure roller and the second pressure roller against the first embossing cylinder and the second embossing cylinder.

4. Device as claimed in claim 1, 2 or 3, wherein said first embossing cylinder and said second embossing cylinder are positioned on said interchangeable assembly in phase with each other.

5. Device as claimed in claim 4, wherein said first embossing cylinder and said second embossing cylinder are phased so that the first protuberances and the second protuberances are arranged in a tip-to-tip configuration.

6. Device as claimed in claim 4, wherein said first embossing cylinder and said second embossing cylinder are phased so that the first protuberances and the second protuberances are in a nested configuration.

7. Device as claimed in claim 6, further comprising a laminating roller mounted on said interchangeable assembly, cooperating with said first embossing cylinder or said second embossing cylinder.

8. Device as claimed in claim 1, wherein said interchangeable assembly carries means to transmit motion from the first embossing cylinder to the second embossing cylinder.

9. Device as claimed in claim 8, wherein said means to transmit motion from the first embossing cylinder to the second embossing cylinder comprise a pair of gears keyed on respective axles of the first embossing cylinder and of the second embossing cylinder.

10. Device as claimed in claim 9, wherein said gears are immersed in an oil bath.

11. Device as claimed in claim 1, wherein said supporting structure comprises a kinematic transmission of movement from a source of motion to said first embossing cylinder or said second embossing cylinder.

12. Device as claimed in claim 11, wherein said kinematic transmission comprises a motorized wheel and a belt to transmit motion to said first embossing cylinder or said second embossing cylinder.

13. Device as claimed in claim 1, wherein said supporting structure comprises two sides with substantially vertically extending portions, in which slots are provided, inside of which corresponding portions of sides of said interchangeable assembly are inserted, an axle of the first embossing cylinder being positioned inside said slots when the interchangeable assembly is mounted on the supporting structure.

14. Device as claimed in claim 11, wherein said kinematic transmission transmits motion to said first embossing cylinder.

15. Device as claimed in claim 13, wherein on an opposite side of said vertically extending portions from said interchangeable assembly said structure carries a gluing unit, cooperating with said first embossing cylinder.

16. Device as claimed in claim 1, wherein at least one of said first pressure roller and said second pressure roller is supported by a pair of arms oscillating around an axis fixed in relation to said supporting structure to adopt at least two different operating positions.

17. Device as claimed in claim 16, wherein said second pressure roller is supported in such as way as to adopt at least two different operating positions.

18. Device as claimed in claim 1, wherein one of said first embossing cylinder and said second embossing cylinder is supported on said interchangeable assembly by arms oscillating around an axis fixed in relation to said interchangeable assembly.

19. Device as claimed in claim 18, wherein when the interchangeable assembly is mounted on the supporting structure, said oscillating arms carrying said one of the first embossing cylinder and the second embossing cylinder cooperate with at least an actuator which presses said first embossing cylinder and said second embossing cylinder against each other.

20. Device as claimed in claim 1, further comprising means for clamping said interchangeable assembly on said supporting structure.

21. Device as claimed in claim 1, further comprising at least two interchangeable assemblies which differ from each other.

22. Device as claimed in claim 21, wherein said at least two interchangeable assemblies are movable on guides to be translated towards or away from said supporting structure.

23. Device as claimed in claim 1, wherein a gluing unit is mounted on said supporting structure.
